(19) United States
(12) Patent Application Publication
(10) Pub. No.: US 2006/0125156 A1
(43) Pub. Date: Jun. 15, 2006

(54) Method of production of composite materials

(75) Inventor: Arthur William Woolhouse, Norwich (GB)

Correspondence Address: KNOBBE MARTENS OLSON & BEAR LLP, 2040 MAIN STREET, FOURTEENTH FLOOR, IRVINE, CA, 92614, US

(73) Assignee: CARBON FIBRE TECHNOLOGIES LIMITED, Norfolk (GB)

(21) Appl. No.: 10/530,009

(22) PCT Filed: Sep. 30, 2003
(86) PCT No.: PCT/GB03/04232

§ 371 Date: Dec. 12, 2005

(30) Foreign Application Priority Data
Oct. 2, 2002 (GB) 0222753.6

(51) Int. Cl. B29C 43/10

(52) U.S. Cl. 264/571; 264/258

(57) ABSTRACT

A method of producing a laminate comprising the following steps: (a) Forming patches from a substantially unidirectional fabric, treated with a resin; (b) Substantially randomising the orientation of said patches; (c) Distributing a plurality of said patches in layers around a former; (d) Causing said layers of patches to amalgamate by means of activation of the resin treatment.

### FIELD OF THE INVENTION

This invention relates to a method of producing advanced composite materials with a substantially laminar construction.

Review of the Art Known to the Applicant(s)

Composite materials have found great application in recent decades, due in part to their ability to combine high strength with the ease of forming complex shapes. One particular class of composite materials, to which this current invention relates, uses fibres made of various materials, bonded together with a resin. The fibres themselves have an inherent strength combined with a flexibility, that allows them to be formed into complex shapes and then bound together with an appropriate resin. The strength of the composite material derives from the inherent strength of the fibres combined with the strength of the bond between them. The desirable mechanical properties of the fibres are intrinsically anisotropic, in that they lie predominantly along the direction of the fibre. However, in the manufacture of articles from such composite materials it is sometimes required that the finished article has isotropic strength characteristics. This design requirement has led to a number of technical solutions, which will be described below, each of which exhibits a number of deficiencies.

The class of composite materials to which this invention refers are known as Polymer Matrix Composites, or Fibre Reinforced Polymers. They use a polymeric resin as a continuous matrix and contain a variety of fibres. Commonly used fibres include carbon fibre, glass, aramid and boron. The overall properties of such composites result from the individual properties of the fibre and of the resin, the ratio of fibre to resin in the composite and the geometry and orientation of the fibres within the composite.

A wide range of resin types are used in the manufacture of resin-fibre composites. These resins or polymers may be thermoplastic, or more usually thermosetting. A wide range of such thermosetting polymers are used in the composite industry, polyester, vinylester and epoxy are common. Properties of the resin are chosen to be compatible with the fibres to be used in the composite. For example, it is important that the adhesive properties of the polymer are such that a strong bond is made between the fibres. In this respect, epoxy systems are regarded as offering high performance. The mechanical properties of the resin system are also important, particularly the tensile strength and stiffness of the cured polymer, as well as the shrinkage of the resin during its curing period. In this respect, again, epoxy resin systems are known to produce low shrinkage rates.

Among the range of fibres available for use in composite manufacture, three are most common in the industry. Glass fibres are typically used either as yarns (closely associated bundles of twisted filaments or strands), rovings (a more loosely associated bundle of untwisted filaments or strands), or spun yarn fibres.

Aramid fibres made from aromatic polyamides, such as those sold under the trade mark ‘Kevlar’ have high strength and low density and have found wide application in protective materials. Carbon fibres, produced by high temperature treatment of polymer fibres, have been used for the last 40 years or so and have high stiffness, tensile and compressive strength, as well as favourable corrosion-resistance properties.

Methods of construction of fibre and resin composite materials fall into two broad classes. The first of these, referred to as ‘Wet Lay-up’ involves adding liquid resin to the fibres at the stage of forming the moulded product. In this mode of processing, a relatively large resin to fibre ratio is produced, and composites of this form are recognised in the art as having inherent weakness. The second mode of construction uses pre-impregnated fibres, and is generally regarded as being superior to the wet lay-up technique. These so-called ‘pre-impregnated’ fibres are well known in the art, and will not be needlessly described here. Within this class there are three approaches that have been used, as follows:

Pre-impregnated Unidirectional and Woven Fabric

Sheets of fabric made from the required fibres may be stacked to form a desired laminate thickness. The sheets may be unidirectional—i.e. with the fibres running in one direction—or woven, with a variety of weave options. This allows a controlled orientation of the fibres so that a manufactured component can be stronger and/or stiffer in the direction of the fibre, in an analogous way to the grain of wood. The weave of the fabric itself is comprised of ‘tows’ which themselves may comprise many thousands of fibres or filaments.

The alignment and bundling of fibres into a tow allows a very strong resin bond to take place between the fibres, unlike the random fibre methods to be described below. This alignment allows the resin content of the composite to be reduced, and to be more uniformly distributed amongst the fibres.

Problems arise, however, when a homogenous construction is required, and the strength and stiffness in a manufactured article needs to be isotropic (i.e. not varying with direction), at least with respect to the major spatial axes. The use of a number of such sheets to create the required thickness in the product introduces an interlaminar weakness. Interlaminar failure and delamination significantly compromise a laminate's structural integrity and performance, and is a common failure mode for composite materials constructed in this manner.

Each ply of fabric is anisotropic in terms of its planar mechanical properties. So, in order to construct an isotropic laminate a significant number of plies are required, but the problem of interlaminar differences are inherent even though the laminate as a whole is quasi-isotropic.

The construction of a quasi-isotropic structure requires a significant number of plies which in turn requires a level of symmetry of fibre direction through the plane and sectional view of a bi-directional thickness in order to avoid distortion of the manufactured article through eg. thermal or shrinkage mechanisms. This requires increased care, and hence manufacturing costs, in the laminating process.

When this type of material is required for complex shapes with tight compound curves, specific tailoring is needed with both woven and unidirectional material. The drapebility of the fabric used is key to the success of this manufacturing technique. Individual plies are cut and spliced to enable the material to conform to the required shape. This can increase interlaminar stresses over a large area.

Chopped Random Fibre and Continuous Random Fibre

Fibre-resin composites may also be made using chopped or continuous random fibres. The use of such fibres requires less effort, and hence reduces the cost of components. The random nature of the fibre orientation means that a construction can be made with essentially isotropic properties.

However, the reduction in cross-linking between parallel fibres is very significant and reduces the overall performance of the laminate. The inherently random nature of the fibre placement causes some areas of the product to be thicker than others unless significant pressure is used to help the distribution, but this contributes further to the reduction in laminate performance as the fibres are distorted in this process.

Furthermore, the random bridging of fibres leaves large voids that get filled with resin. This increases the weight of the component. Therefore the control on resin to fibre ratio is poor which generally means the mechanical properties are worse than with pre-impregnated fabric.

Finally, the Fibre Area Weight (FAW)—i.e. the weight of a given area of a sheet or product—is not as consistent in this mode of manufacture, as may be obtained by use of pre-impregnated unidirectional or woven fabric.

Random Chopped Fibre in Moulding Compound

A final way of constructing resin-fibre laminates is by the use of random chopped fibres in a moulding compound. In a number of applications, for example in the manufacture of protective helmets, an unsaturated polyester resin moulding compound is used, reinforced with pre-impregnated glass fibre. This method usually uses comparatively short fibres, with a consequently adverse effect on the material properties. The overall performance of this type of material is recognised to be significantly worse than that produced by the methods described above.

The present invention addresses these problems of conventional resin-fibre laminate technology, and produces a laminate that is essentially anisotropic, has favourable mechanical properties in terms of strength and stiffness, and is significantly less prone to de-lamination failure.

### SUMMARY OF THE INVENTION

In the broadest definition of the invention, there is provided a method of producing a laminate comprising the following steps:

(a) Forming patches from a substantially unidirectional fabric, treated with a resin

(b) Substantially randomising the orientation of said patches

(c) Distributing a plurality of said patches in layers around a former

(d) Causing said layers of patches to amalgamate by means of activation of the resin treatment.

Advantageously, the means for distributing patches in step (c) is a suction device.

Advantageously also, the means for distributing patches in step (c) is a pneumatic conveyor.

Preferably, in any of the definitions of the methods of the invention, the said patches have an average surface area no greater than 20% of the surface area of the layer formed in step (c).

More preferably, in any of the definitions of the methods of the invention, a multiplicity of patch shapes and/or sizes is employed.

Included within the scope of the invention, is a method of producing a laminate substantially as described herein, with reference to and as illustrated by any appropriate combination of the accompanying drawings.

### BRIEF DESCRIPTION OF THE DRAWINGS

FIG. 1 is a schematic process diagram illustrating the formation of fabric patches, their randomisation, and their presentation for fiber processing.

FIG. 2 is a schematic process diagram illustrating the formation of patches, their randomisation, and subsequent conveyance to a moulding process.

FIG. 3 illustrates a range of patch shapes suitable for use in the current invention.

FIG. 4 illustrates a typical random arrangement of patches in a composite polymer.

FIG. 5 is a schematic diagram of a cross-section through a composite laminate as made by existing technology.

FIG. 6 is a schematic diagram showing a cross-section through a composite laminate made according to the method of the current invention.

### DESCRIPTION OF THE PREFERRED EMBODIMENT

To overcome the deficiencies of existing methods of composite manufacture, the method of the present invention comprises the use of a large number of randomly-orientated patches of orientated fibres. Preferably, these are patches of unidirectional fabric, i.e. a fabric in which the majority of fibres run in one direction only. It is commonly understood in the art that such unidirectional fabrics may have a small amount of fibre or other material running in another direction, with the intention of holding the primary fibres in position. It is preferable that the unidirectional fabric used in the method of manufacture of the preferable that the unidirectional fabric used in the method of manufacture of the composite is pre-impregnated, or pre-treated, with an appropriate resin system in order to produce a high fibre to resin ratio in the final composite. This is difficult to achieve with the Wet Lay-up technique. The patches used in the manufacture of this ‘Random Stamp Laminate’ are chosen to have a size and shape appropriate to the geometry of the required final product, as will be discussed below. The laminate is then formed by layering, in an essentially random way, the patches to the required shape of the final articles. Following this layering process, the patches are compressed if required and then cured in the conventional way, appropriate to the resin system in use.

One embodiment of such a production process is illustrated in FIG. 1. Unidirectional fabric 1 as sheet or roll material is fed into apparatus 2 comprising the means for producing the fabric patches 3 of the required range of sizes and shapes. The patches 3 are fed into apparatus such as a tumbler 4 providing means for randomly orientating the patches 3. On leaving the tumbler 4 the randomly orientated patches 5 may fall onto a conveyer belt 6 to form a loose, randomly orientated layer 7 of patches. The randomly orientated patches 7 may then be conveniently picked up by use of a suction head 8 for transfer to a product mould by, for example, robotic means.

In an analogous way, the randomly orientated patches 5 could be fed into a hopper for eventual delivery to such a suction head device.

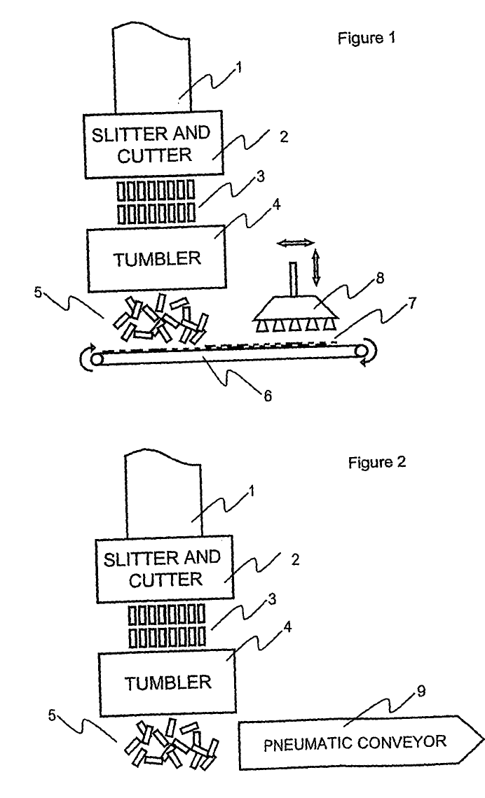

FIG. 2 shows another embodiment of the production process whereby the randomly orientated patches 5 are conveyed from the tumbler 4 by means of a pneumatic conveyor. Such conveyors are known for handling powdered or granular materials. Control of temperature in such a conveyor can be used to prevent patches sticking to each other, or to the conveyor, during transport. The patches may then be conveniently deposited in layers, to the required geometry, optionally with the assistance of a vacuum-forming device.

The shape and size of the patches used to form the random stamp laminate may be chosen according to the size and geometry of the object to be manufactured. Any particular object to be manufactured may use patches of a range of sizes and shapes, either distributed randomly over the surface of the object, or patches of a particular shape or size may be positioned, or orientated, at particular locations on the object to provide localised areas of specific strength characteristics, such as local anisotropy. It is to be appreciated that there is a trade off between the ability to follow a curved geometry and the strength of the composite produced. Small patches will be more able to follow complex geometries, but at the expense of the strength that derives from long fibre length.

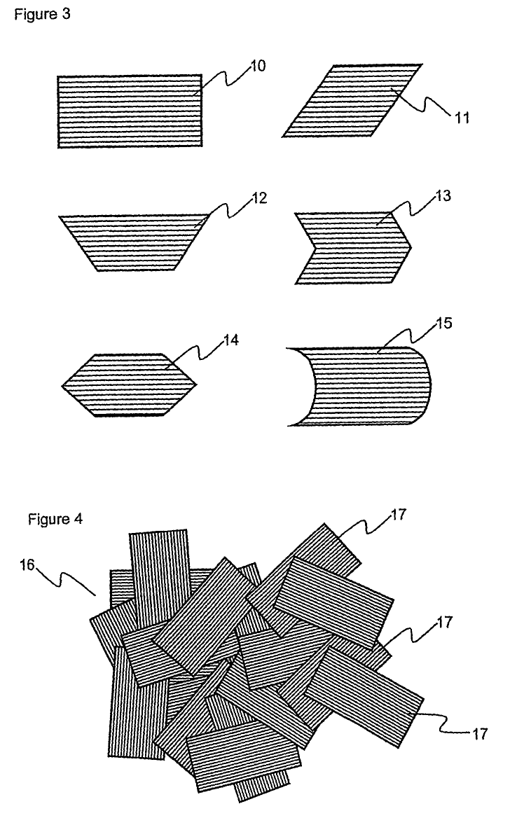

FIG. 3 illustrates a range of suitable geometries for the patches. All the patches depicted are capable of tesselating, thus making most efficient use of the sheet or roll unidirectional fabric, although this property is not essential for operation of the present method. Referring to FIG. 3, appropriate shapes depicted are a rectangle 10, a parallelogram 11, a trapezium 12, a chevron 13, a hexagon 14 and a curved arrow 15. The lines in each of the shapes depicted in FIG. 3 indicate the preferred direction of the fibres in the unidirectional sheet, by providing the most efficient way to maximise the fibre length within the patch.

FIG. 4 depicts, again schematically, a small section 16 of a composite laminate made according to the method of this invention. This view, perpendicular to the plane of the randomly orientated patches 17, shows a typical arrangement of the patches. In this instance, rectangular patches of a uniform size are depicted, but a range of sizes and shapes could equally be used as required.

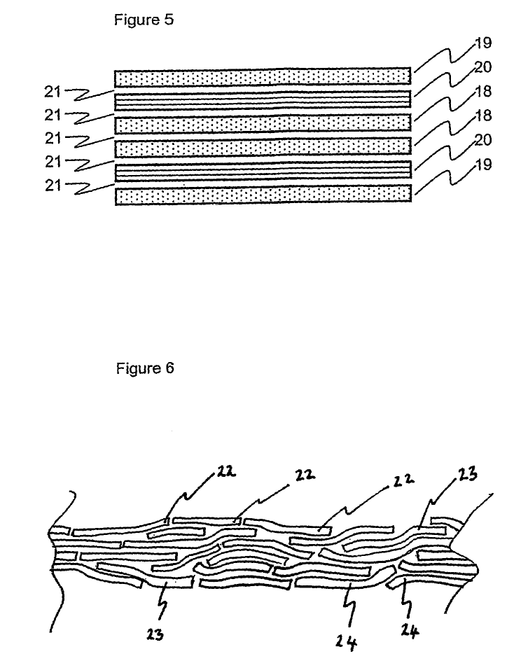

A key advantage of this method of production of advanced composite materials is that the problem of delamination under stress is significantly reduced. FIG. 5 shows a schematic representation of a section through a typical six ply laminate composite made according to existing methodology. The two central plies 18 as illustrated are formed of unidirectional fabric with the fibre direction running normal to the plane of the diagram. The two outer plies 19 are similarly orientated. The two intermediate plies 20 have unidirectional fibres lying along the plane of the diagram, as indicated by the horizontal stripes. It can be seen that in this construction there are clear interlaminar ‘strata’ 21. In the final composite, of course, these would be composed of the resin material. They are, however, a plane of weakness in the material along which delamination failure often occurs.

By contrast, FIG. 6 is a diagrammatic representation of a section through a composite made according to the method of the current invention. It will be appreciated that the diagram is schematic, and that in order to clarify the description, the patches are depicted as being thicker, shorter and more kinked than would be preferable. The diagram shows sections through a large number of patches 22, 23, 24, each composed of unidirectional fabric, and each patch orientated in a random fashion as described earlier. As a result of the random way in which the patches are placed on the former, a number of features of the invention are apparent. Whilst some patches may abut each other, although with a random orientation of the fabric, others, for example those depicted as patches 24 overlap at their edges. Still further patches, such as those depicted at 23, traverse at least part of the thickness of the composite laminate. It will be noted that unlike the traditional laminates depicted in FIG. 5, the laminate produced by the current invention has a much less stratified structure. These features contribute in great part to the improved characteristics of the composite. The overlapping and thickness-traversing patches serve to prevent delamination, and to spread stresses throughout the structure of the composite.

The invention is defined in the claims that follow and in which the term “unidirectional fabric” is understood to encompass fabrics in which most of the fibres are aligned in substantially the same direction, and may contain fibres running in other directions with the intention of holding the primary fibres in position. Typically, in the art, more than 75% of the fibres are aligned in substantially the same direction.

The term “former” is understood to be any means of causing the spatial association of patches. The term former includes, therefore, means commonly referred to as a mould, which may contain a number of convex and concave curves. The term former also includes substantially planar surfaces.

The term “resin” is understood to include any polymeric material capable of binding the fibres of the fabric together, and “means of activation” is understood to include heat, radiation, catalysis, chemical reaction and drying.

Laminates produced according to the method of this invention are described in the co-pending application filed by our agent the same day, under the title ‘Advanced Composite Materials’.

1-7. (canceled)

8. A method of producing a laminate comprising the following steps:
Forming patches from a substantially unidirectional fabric, treated with a resin; the patches being formed to predetermined shape(s) and size(s) to suit the product in which the laminate is to be used;
Forming substantially loose and randomly oriented patches;
Distributing said substantially loose and randomly oriented patches in layers around a product mould;
Causing said layers of patches once distributed around said product mould to amalgamate by means of activation of the resin treatment.

9. The method of claim 8 wherein the means for distributing patches in step (c) is a suction device.

10. The method of claim 8 wherein the means for distributing patches in step (c) is a pneumatic conveyor.

11. The method of claim 8 in which the said patches have an average surface area of no greater than 20% of the surface area of the layer formed in step (c).

12. The method of claim 8 in which a multiplicity of patch shapes and/or sizes is employed.

13. The method of claim 8, wherein the distributing step is carried out at a controlled temperature, whereby patches are prevented from sticking to each other during said step.

14. The method of claim 8, comprising the step of forming a group of patches where one or more patches traverse at least part of the thickness of said laminate.

15. A laminate comprising randomly orientated patches each formed from a substantially unidirectional fabric treated with a resin and all amalgamated by means of activation of the resin treatment.

16. The laminate of claim 15 in which the said patches have an average surface area of no greater than 20% of the surface area of the laminate.

17. The laminate of claims 15 in which a multiplicity of patch shapes and/or sizes is employed.
